(19) United States
(12) Patent Application Publication
(10) Pub. No.: US 2017/0308701 A1
(43) Pub. Date: Oct. 26, 2017

(54) Methods and Systems for Intelligently Detecting Malware and Attacks on Client Computing Devices and Corporate Networks

(71) Applicant: QUALCOMM Incorporated, San Diego, CA (US)

(72) Inventors: Sriram Nandha Premnath, San Jose, CA (US); Saumitra Mohan Das, Santa Clara, CA (US); Rajarshi Gupta, Sunnyvale, CA (US)

(21) Appl. No.: 15/135,855

(22) Filed: Apr. 22, 2016

(51) Int. Cl. G06F 21/56; G06F 21/53; G06F 21/60

(52) U.S. Cl. CPC G06F 21/566; G06F 21/606; G06F 21/53; G06F 2221/033

(57) ABSTRACT

A network and its devices may be protected from non-benign behavior, malware, and cyber attacks caused by downloading software by configuring a server computing device to work in conjunction with the devices in the network. The server computing device may be configured to receive a software application from an application download service, establish a secure communication link to a client computing device in the network, receive exercise information from the client computing device via the secure communication link, use the received exercise information to exercise the received software application in a client computing device emulator to identify one or more behaviors, and determine whether the identified behaviors are benign. The server computing device may send the software application to the client computing device in response to determining that the identified behaviors are benign, and quarantine the software application in response to determining that the identified behaviors are not benign.

### BACKGROUND

Cellular and wireless communication technologies have seen explosive growth over the past several years. Wireless service providers now offer a wide array of features and services that provide their users with unprecedented levels of access to information, resources and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications on their devices. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, mobile device users frequently use their devices to purchase goods, send and receive sensitive communications, pay bills, manage bank accounts, and conduct other sensitive transactions. Due to these trends, mobile devices are becoming the next frontier for malware and cyber attacks. Accordingly, new and improved security solutions that better protect resource-constrained computing devices, such as mobile and wireless devices, will be beneficial to consumers.

### SUMMARY

The various embodiments include methods of protecting computing devices from non-benign software applications, which may include receiving by a processor in a server computing device a software application from an application download service, establishing by the processor a secure communication link to a client computing device, receiving by the processor exercise information from the client computing device via the secure communication link, using the received exercise information by the processor to exercise (e.g., execute) the received software application in a client computing device emulator to identify one or more behaviors, and determining by the processor whether the identified behaviors are benign.

In some embodiments, using the received exercise information by the processor to exercise the received software application in the client computing device emulator to identify one or more behaviors may include analyzing the software application in an application analyzer component of the client computing device emulator to identify aspects of the software application warranting observation, and selecting targeted activities of the software application for exercising based on the received exercise information and analysis of the software application. Such embodiments may further include triggering the selected targeted activities of the software application for execution, and observing behaviors of the software application during execution of triggered activities, and further selecting new target activities based on runtime behavior of the software application. Such embodiments may further include analyzing a layout of a graphical user interface, and using results of analysis of the graphical user interface when triggering the selected targeted activities of the software application for execution.

Some embodiments may include quarantining by the processor the software application received from the application download service in response to determining that the identified behaviors are not benign, and sending a notification message that includes information identifying the software application as non-benign to the client computing device. Some embodiments may include sending the software application received from the application download service to the client computing device in response to determining that the identified behaviors are benign.

Some embodiments may include receiving additional exercise information from the client computing device via the secure communication link in response to sending software application received from the application download service to the client computing device. Such embodiments may include using the additional exercise information to further exercise the received software application and identify an additional behavior, and determining whether the identified additional behavior is benign. In some embodiments, receiving the exercise information from the client computing device may include receiving information identifying a confidence level for the software application, a list of activities (e.g., GUI screens, etc.) in the application that are explored, a list of explored graphical user interface (GUI) screens, a list of unexplored activities of the application, a list of unexplored GUI screens, a list of unexplored behaviors, hardware configuration information, or software configuration information.

Some embodiments may include computing a risk score for the received software application, and sending the computed risk score to the client computing device via the secure communication link.

Some embodiments may include receiving the software application in the client computing device, commencing execution of the software application on the client computing device, and monitoring activities of the software application to collect behavior information. Such embodiments may include generating a vector data structure that describes the collected behavior information via a plurality of numbers or symbols, applying the vector data structure to a machine learning classifier model to generate an analysis result, and using the generated analysis result to determine whether the software application is benign. Some embodiments may include sending the generated analysis result from the client computing device to the server computing device as the exercise information in response to determining that the software application is not benign.

Some embodiments may include receiving a communication request message from the client computing device. In such embodiments, establishing the secure communication link to the client computing device may include establishing the secure communication link to the client computing device in response to receiving the communication request message from the client computing device.

Further embodiments include a server computing device that includes a processor configured with processor-executable instructions to perform operations of the methods summarized above. Further embodiments include a non-transitory computer readable storage medium having stored thereon processor-executable software instructions configured to cause a processor in a server computing device to perform operations of the methods summarized above. Further embodiments include a computing device having means for performing functions of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating network components of an example telecommunication system that is suitable for use with various embodiments.

FIG. 2 is a block diagram illustrating example logical components and information flows in an embodiment system configured in accordance with various embodiments.

FIG. 3 is a block diagram illustrating additional components and information flows in an embodiment system that is configured to protect a corporate network and its devices in accordance with various embodiments.

FIG. 4A is a process flow diagram illustrating a method for protecting a corporate network and client devices in accordance with various embodiments.

FIG. 4B is a process flow diagram illustrating a method of exercising a software application in an emulator in accordance with various embodiments.

FIG. 5 is a component block diagram of a client computing device suitable for use with various embodiments.

FIG. 6 is a component block diagram of a server device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, various embodiments include methods, and devices (e.g., server computing devices, client computing devices, etc.) configured to implement the methods, for protecting a corporate network and mobile computing devices from malware and other non-benign applications or behaviors that may degrade the performance of the computing device or corporate network.

Various embodiments may include a server computing device that is configured with software module or executable code for testing software applications for client devices through multiple user interactions to detect potential non-benign behaviors. Consistent with terms used in the art, the software application performing operations of the various embodiments is referred to as a “detonator component.” The detonator component may be configured to receive or intercept a software application that is requested by a client computing device (e.g., a mobile or resource-constrained computing device, etc.) from an application download service (e.g., Apple® App Store, Windows® Store, Google® play, etc.). The detonator component may emulate the client computing device, and exercise or stress test the received/intercepted software application through a variety of configurations, operations, and user interactions. By observing operations and behaviors during such exercising, the detonator component may perform various analysis operations (e.g., static analysis operations, dynamic analysis operations, behavior-based analysis operations, etc.) to determine whether the software application is benign or non-benign. The detonator component may take various corrective or preventive actions in response to determining that the software application program is non-benign. For example, the detonator component may quarantine a software application that is determined to be non-benign, prevent client computing devices from downloading a non-benign software application, notify a corporate or information technology (IT) security system that a client device attempted to download malware (and thus could be experiencing a cyber attack or otherwise needs scrutiny or evaluation), notify client computing devices that the requested application should be blocked, deleted or not downloaded, and perform other similar operations.

The various embodiments may include a client computing device that is configured to perform various operations to accomplish client-driven detonation. For example, the client computing device may be configured to establish a secure communication link to a detonator component or server computing device, and use the secure communication link to request that the detonator component evaluate specific aspects or behaviors of the software application (e.g., in response to the client computing device determining that the software application is suspicious, non-benign, etc.).

In some embodiments, the client computing device may be equipped with an on-device security system that is configured to use behavioral analysis and machine learning techniques to identify, prevent, respond to and/or correct non-benign behaviors. As part of these operations, the on-device security system may monitor device behaviors, generate behavior information structures (e.g., behavior vectors), apply the behavior information structures to classifier models to generate behavior analysis results, and use the behavior analysis results to determine whether a software application or device behavior is benign or non-benign.

In response to determining that a software application or device behavior is suspicious (e.g., cannot be classified as benign or non-benign with a sufficiently high degree of confidence based on the comparison or analysis results, etc.), the client computing device may collect and send exercise information to the detonator component via the secure communication link, and request that the detonator component further analyze the software application. The exercise information may include information identifying a confidence level for the software application, a list of activities in the application that are explored, a list of GUI screens that are explored, a list of activities of the application that are unexplored, a list of GUI screens that are unexplored, a list of unexplored behaviors, hardware configuration information, software configuration information, collected behavior information, generated behavior vectors, classifier models, the results of its analysis operations, locations of buttons, text boxes or other electronic user input components that are displayed on the electronic display of the client device, and other similar information. The server computing device may receive and use the exercise information to update its client computing device emulator and/or focus its operations on evaluating specific behaviors activities, screens, user interface elements, electronic keys, layouts, etc.

In some embodiments, the client computing device may be configured to receive information (e.g., risk scores, confidence values, rankings, etc.) from the detonator or server computing device, and use the received information to evaluate (or further evaluate) the software application and/or determine whether the software application is benign or non-benign.

The detonator component may be configured to securely receive exercise information (e.g., behavior information, classifier models, behavior vectors, etc.) regarding a software application from the client computing device via the secure communication link. In some embodiments, the server computing device may be configured to use the emulation or analysis results (e.g., results generated from performing the static and/or dynamic analysis operations) to generate exercise information, and send the exercise information to the client computing device. The exercise information may include behavior information, behavior vectors, classifier models, the results of its analysis operations, confidence levels, risk scores, list of explored activities or graphical user interface (GUI) screens, list of unexplored GUI screens or activities, hardware configuration information, software configuration information, rankings, security scores, and other similar information. In an embodiment, the exercise information may include a behavior vector (an information structure) that succinctly describes or characterizes the activities of the software application (e.g., via a series of numbers or symbols, etc.).

The various embodiments improve the functioning of a computing device by improving its security, performance, and power consumption characteristics. For example, by comparing information received from the server to information collected in the device to determine whether a software application is suspicious, the various embodiments allow the computing device to quickly and intelligently determine whether to perform additional analysis operations or request that a server perform a more robust analysis of the software application. This improves the device's performance and power consumption characteristics by allowing the device to offload processor or battery intensive operations and control the features or factors that are evaluated by the detonator component (e.g., by sending exercise information via the secure link). Additional improvements to the functions, functionalities, and/or functioning of computing devices will be evident from the detailed descriptions of the embodiments provided below.

Phrases such as “performance degradation,” “degradation in performance” and the like may be used in this application to refer to a wide variety of undesirable operations and characteristics of a network or computing device, such as longer processing times, slower real time responsiveness, lower battery life, loss of private data, malicious economic activity (e.g., sending unauthorized premium short message service (SMS) message), denial of service (DoS), poorly written or designed software applications, malicious software, malware, viruses, fragmented memory, operations relating to commandeering the device or utilizing the device for spying or botnet activities, etc. Also, behaviors, activities, and conditions that degrade performance for any of these reasons are referred to herein as “not benign” or “non-benign.”

The terms “client computing device,” and “mobile computing device,” are used generically and interchangeably in this application, and refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar electronic devices which include a memory, a programmable processor for which performance is important, and operate under battery power such that power conservation methods are of benefit. While the various embodiments are particularly useful for client computing devices, which are resource-constrained systems, the embodiments are generally useful in any computing device that includes a processor and executes software applications.

Modern computing devices enable their users to download and execute a variety of software applications from application download services (e.g., Apple App Store, Windows Store, Google play, etc.) or the Internet. Many of these applications are susceptible to and/or contain malware, adware, bugs, or other non-benign elements. As a result, downloading and executing these applications on a computing device may degrade the performance of the corporate network and/or the computing devices. Therefore, it is important to ensure that only benign applications are downloaded into computing devices or corporate networks.

Recently, Google/Android has developed a tool called “The Monkey” that allows users to “stress-test” software applications. This tool may be run as an emulator to generate pseudo-random streams of user events (e.g., clicks, touches, gestures, etc.) and system-level events (e.g., display settings changed event, session ending event, etc.) that developers may use to stress-test software applications. While such conventional tools (e.g., The Monkey, etc.) may be useful to some extent, they are, however, unsuitable for systematic/intelligent/smart evaluation of “Apps” or software applications with rich graphical user interface typical of software applications that are designed for execution and use in mobile computing devices or other resource-constrained devices.

There are a number of limitations with conventional stress-test tools that prevent such tools from intelligently identifying malware and/or other non-benign applications before the applications are downloaded and executed on a client computing device. First, most conventional emulators are designed for execution on a desktop environment and/or for emulating software applications that are designed for execution in a desktop environment. Desktop applications (i.e., software applications that are designed for execution in a desktop environment) are developed at a much slower rate than apps (i.e., software applications that are designed primarily for execution in a mobile or resource-constrained environment). For this reason, conventional solutions typically do not include the features and functionality for evaluating applications quickly, efficiently (i.e., without using extensive processing or battery resources), or adaptively (i.e., based on real data collected in the “wild” or “field” by other mobile computing devices that execute the same or similar applications).

Further, mobile computing devices are resource constrained systems that have relatively limited processing, memory and energy resources, and these conventional solutions may require the execution of computationally-intensive processes in the mobile computing device. As such, implementing or performing these conventional solutions in a mobile computing device may have a significant negative and/or user-perceivable impact on the responsiveness, performance, or power consumption characteristics of the mobile computing device.

In addition, many conventional solutions (e.g., “The Monkey,” etc.) generate a pseudo-random streams of events that cause the software application to perform a limited number of operations. These streams may only be used to evaluate a limited number of conditions, features, or factors. Yet, modern mobile computing devices are highly configurable and complex systems, and include a large variety of conditions, factors and features that could require analysis to identify a non-benign behavior. As a result, conventional solutions such as The Monkey do not fully stress test apps or mobile computing devices applications because they cannot evaluate all the conditions, features, or factors that could require analysis in mobile computing devices. For example, The Monkey and other conventional tools do not adequately identify the presence, existence or locations of buttons, text boxes, or other electronic user input components that are displayed on the electronic display screens of mobile computing devices. As a result, these solutions cannot adequately stress test or evaluate these features (e.g., electronic user input components, etc.) to determining whether a mobile computing device application is benign or non-benign.

Further, conventional tools do not intelligently determine the number of activities or screens used by a software application or mobile computing devices, or the relative importance of individual activities or screens. In addition, conventional tools use fabricated test data (i.e., data that is determined in advance of a program's execution) to evaluative software applications, as opposed to real or live data that is collected from the use of the software application on mobile computing devices. For all these reasons, conventional tools for stress testing software applications do not adequately or fully “exercise” or stress test software applications that are designed for execution on mobile computing devices, and are otherwise not suitable for identifying non-benign applications before they are downloaded onto a corporate networks and/or before they are downloaded, installed, or executed on mobile computing devices.

The various embodiments include computing devices that are configured to overcome the above-mentioned limitations of conventional solutions, and identify non-benign applications before the applications are downloaded onto a corporate or private network and/or before the applications are downloaded and installed on a client computing device.

The various embodiments may include a server computing device that includes a server processor that is configured to receive a software application from an application download service, establish a secure communication link to a client computing device, and receive exercise information from the client computing device via the secure communication link. Examples of exercise information that may be received by the server may include information identifying a confidence level for the software application, a list of explored activities, a list of explored GUI screens, a list of unexplored activities, a list of unexplored GUI screens, a list of unexplored behaviors, hardware configuration information, software configuration information, etc.). The server may use the received exercise information to exercise/execute the received software application in a client computing device emulator to identify one or more behaviors. Based on observations of behaviors of the emulator during such exercises, the server may determine how to trigger a sequence of activities that will lead to the desired behavior, and then trigger the identified behaviors. The server may observe behaviors of the emulator when the identified behaviors are triggered, and determine whether the software application and/or identified behaviors are benign. The computing device may quarantine the software application in response to determining that the software application or any of the identified behaviors are not benign, or send the software application to the client computing device in response to determining that the identified behaviors are benign. In some embodiments, the server computing device may also compute a risk score for the received software application, and send the computed risk score to the client computing device via the secure communication link.

The client computing device may receive and execute the software application, and dynamically select a behavior for observation. The client computing device may adaptively observe the dynamically selected behavior to collect behavior information. Based on the observations, the client computing device may generate a vector data structure that describes the collected behavior information via a plurality of numbers or symbols. The client computing device may apply the vector data structure to a machine learning classifier model to generate an analysis result, and use the generated analysis result to determining the software application is suspicious. The client computing device may collect and send additional exercise information to the server computing device via the secure communication link in response to determining that the software application is suspicious.

The server computing device may receive the additional exercise information from the client computing device via the secure communication link. The server computing device may use the additional exercise information to further exercise the received software application and identify additional behaviors. Observing the identified additional behaviors, the server computing device may determine whether the identified additional behavior is benign or not benign.

In some embodiments, the server computing device may be configured to intelligently identify malware and/or other non-benign applications before the applications are downloaded onto a corporate network and/or before the applications are downloaded, installed, or executed on a client computing device.

In some embodiments, the server computing device may be configured to exercise, evaluate or stress test “Apps” or software applications that are designed for execution and use in mobile or other resource-constrained computing devices.

In some embodiments, the server computing device may be configured to evaluate a large variety of conditions, factors and features of the software application and/or client computing device to determine whether a behavior or software application is non-benign.

In some embodiments, the server computing device may be configured to evaluate apps quickly, efficiently, and adaptively without having a significant negative and/or user-perceivable impact on the responsiveness, performance, or power consumption characteristics of the client computing device.

In some embodiments, the server computing device may be configured to identify the presence, existence or locations of buttons, text boxes, or other electronic user input components that are displayed on the electronic display screens of client computing devices, and evaluate any or all of these identified conditions, features, or factors to determine whether a behavior or software application is non-benign.

In some embodiments, the server computing device may be configured to determine the number of activities or screens used by a software application, determine the relative importance of individual activities or screens, and use this information to determine whether a behavior or software application is non-benign.

In some embodiments, the server computing device may be configured to use real or live data that is collected from the use of the software application on a client computing device to more fully exercise or stress test software applications that are designed for execution on a client computing device.

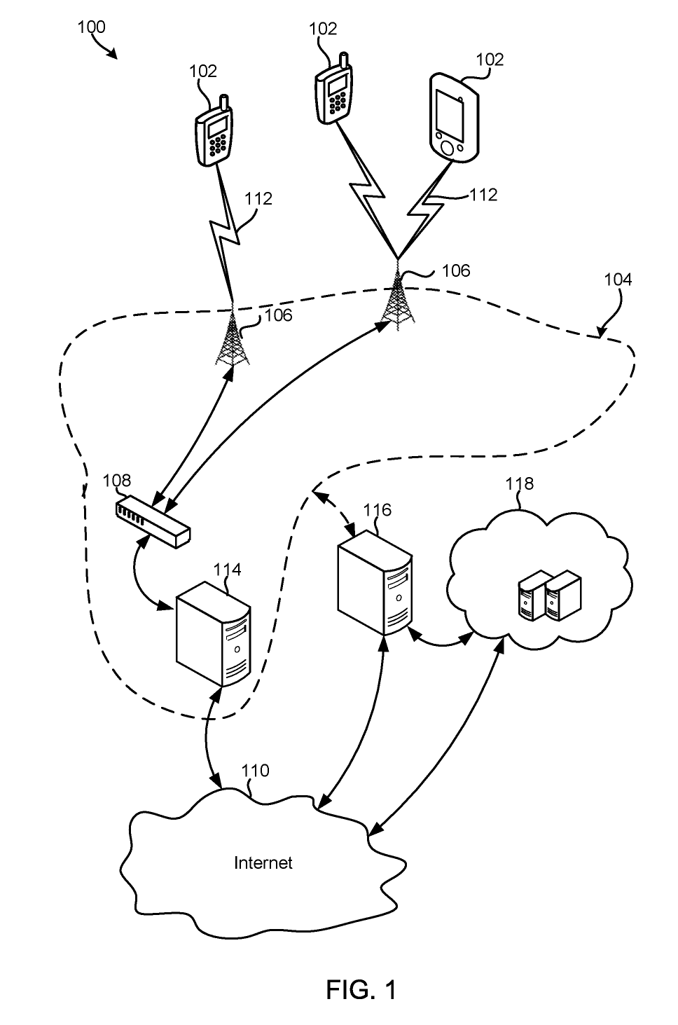

Various embodiments may be implemented within a variety of communication systems, such as the example communication system 100 illustrated in FIG. 1. A typical cell telephone network 104 includes a plurality of cell base stations 106 coupled to a network operations center 108, which operates to connect calls (e.g., voice calls or video calls) and data between client computing devices 102 (e.g., cell phones, laptops, tablets, etc.) and other network destinations, such as via telephone land lines (e.g., a plain old telephone service (POTS) network, not shown) and the Internet 110. Communications between the client computing devices 102 and the telephone network 104 may be accomplished via two-way wireless communication links 112, such as fourth generation (4G), third generation (3G), code division multiple access (CDMA), time division multiple access (TDMA), long term evolution (LTE) and/or other mobile communication technologies. The telephone network 104 may also include one or more servers 114 coupled to or within the network operations center 108 that provide a connection to the Internet 110.

The communication system 100 may further include network servers 116 connected to the telephone network 104 and to the Internet 110. The connection between the network servers 116 and the telephone network 104 may be through the Internet 110 or through a private network (as illustrated by the dashed arrows). A network server 116 may also be implemented as a server within the network infrastructure of a cloud service provider network 118. Communication between the network server 116 and the client computing devices 102 may be achieved through the telephone network 104, the internet 110, private network (not illustrated), or any combination thereof. In an embodiment, the network server 116 may be configured to establish a secure communication link to the client computing device 102, and securely communicate information (e.g., behavior information, classifier models, behavior vectors, etc.) via the secure communication link.

The client computing devices 102 may request the download of software applications from a private network, application download service, or cloud service provider network 118. The network server 116 may be equipped with an emulator, exerciser, and/or detonator components that are configured to receive or intercept a software application that is requested by a client computing device 102. The emulator, exerciser, and/or detonator components may also be configured to emulate the client computing device 102, exercise or stress test the received/intercepted software application, and perform various analysis operations to determine whether the software application is benign or non-benign.

Thus, the network server 116 may be configured to intercept software applications before they are downloaded to the client computing device 102, emulate a client computing device 102, exercise or stress test the intercepted software applications, and determine whether any of the intercepted software applications are benign or non-benign. In some embodiments, the network server 116 may be equipped with a behavior-based security system that is configured to determine whether the software application is benign or non-benign. In an embodiment, the behavior-based security system may be configured to generate machine learning classifier models (e.g., an information structure that includes component lists, decision nodes, etc.), generate behavior vectors (e.g., an information structure that characterizes a device behavior and/or represents collected behavior information via a plurality of numbers or symbols), apply the generated behavior vectors to the generated machine learning classifier models to generate an analysis result, and use the generated analysis result to classify the software application as benign or non-benign.

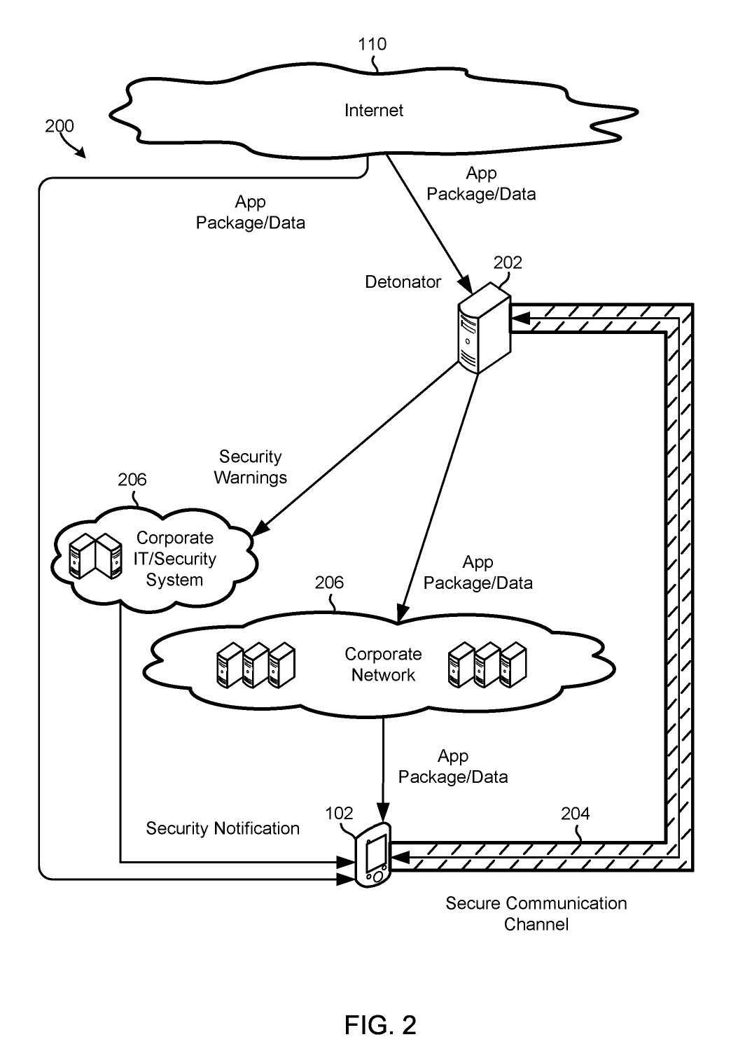

FIG. 2 illustrates an example system 200 that includes a detonator component 202 that may be configured to intercept and evaluate software application in accordance with the various embodiments. In the example illustrated in FIG. 2, a secure communication link 204 is established between the detonator component 202 and the client computing device 102. In some embodiments, the client computing device 102 may establish the secure communication link 204 to the detonator component 202. In other embodiments, the detonator component 202 may establish the secure communication link 204 to the client computing device 102.

In various embodiments, the detonator component 202 may establish the secure communication link 204 to the client computing device 102 in response to receiving a request to download an application from the client computing device 102, in response to determining that it has receive a software application requested by the client computing device 102, etc. In various embodiments, the client computing device 102 may establish the secure communication link 204 to the detonator component 202 in response to determining that a software application is to be downloaded from an application download service, in response to receiving the software application, in response to determining that the received software application is suspicious or non-benign, etc.

The detonator component 202 may be configured to receive exercise information (e.g., confidence level, a list of explored activities, a list of explored GUI screens, a list of unexplored activities, a list of unexplored GUI screens, a list of unexplored behaviors, hardware configuration information, software configuration information, behavior vectors, etc.) from the client computing device 102 via the secure communication link 204. The detonator component 202 may also send information (e.g., risk score, security rating, behavior vectors, classifier models, etc.) to the client computing device 102 via the secure communication link 204.

The detonator component 202 may be configured to receive a software application (or application package, application data, etc.) from an application download service or via the internet 110. The detonator component 202 may be configured to exercise or stress test the received software application in a client computing device emulator. The detonator component 202 may be configured to identify one or more activities or behaviors of the software application and/or client computing device 102, and rank the activities or behaviors in accordance with their level of importance. The detonator component 202 may be configured to prioritize the activities or behaviors based on their rank, and analyze the activities or behaviors in accordance with their priorities. The detonator component 202 may be configured to generate analysis results, and use the analysis results to determine whether the identified behaviors are benign or non-benign.

The detonator component 202 may send the received software application (or application package, application data, etc.) to, or otherwise allow the software application to be received in, the corporate network 206. The corporate network 206 may include components that are configured to send the software application to the client computing device 102.

In response to determining that the software application or any of identified behaviors are non-benign, the detonator component 202 may quarantine the software application and send security warnings or notification messages to a corporate or IT/Security system 206. In response, the corporate or IT/Security system 206 may send notification message that includes information identifying the software application as non-benign to the client computing device 102 and/or take other corrective or preventive measures.

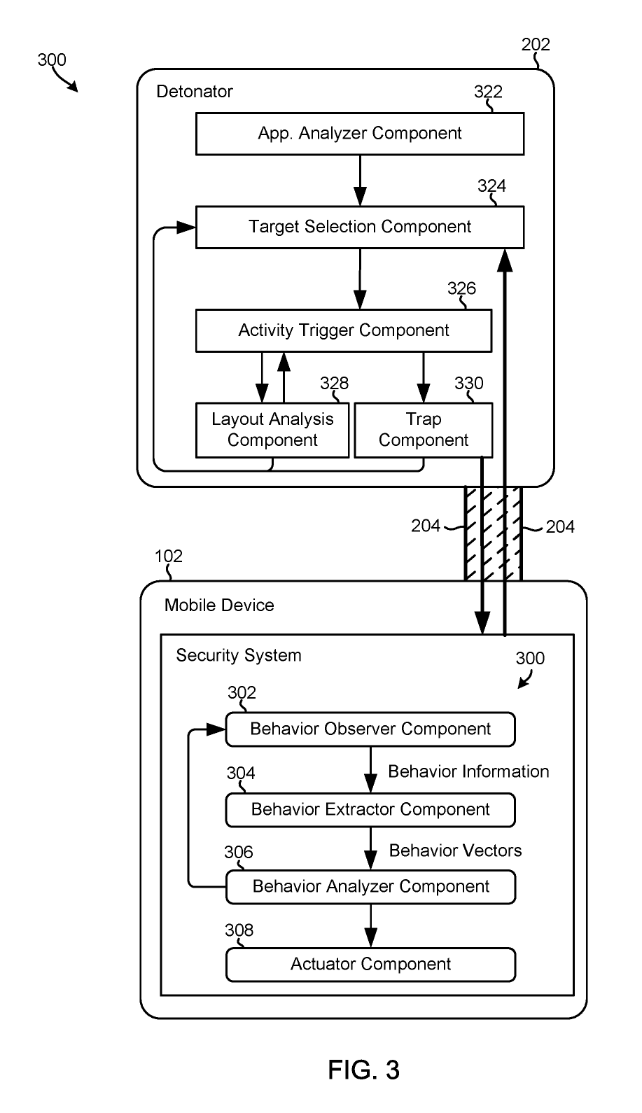

FIG. 3 illustrates various components and information flows in a system 300 that includes a detonator component 202 executing in a server and a client computing device 102 configured in accordance with the various embodiments. In the example illustrated in FIG. 3, the detonator component 202 includes an application analyzer component 322, a target selection component 324, an activity trigger component 326, a layout analysis component 328, and a trap component 330. The client computing device 102 includes a security system 300 that includes a behavior observer component 302, a behavior extractor component 304, a behavior analyzer component 306, and an actuator component 308.

As mentioned above, the detonator component 202 may be configured to exercise a software application (e.g., in a client computing device emulator) to identify one or more behaviors of the software application and/or client computing device 102, and determine whether the identified behaviors are benign or non-benign. As part of these operations, the detonator component 202 may perform static and/or dynamic analysis operations. The static analysis operations may include analyzing byte code (e.g., code of a software application uploaded to an application download service) to identify code paths, evaluating the intent of the software application (e.g., to determine whether it is malicious, etc.), and performing other similar operations to identify all or many of the possible operations or behavior of the software application. The dynamic analysis operations may include executing the byte code via an emulator (e.g., in the cloud, etc.) to determine all or many of its behaviors and/or to identify non-benign behaviors. In an embodiment, the detonator component 202 may be configured to use a combination of the information generated from the static and dynamic analysis operations (e.g., a combination of the static and dynamic analysis results) to determine whether the software application or behavior is benign or non-benign. For example, the detonator component 202 may be configured to use static analysis to populate a behavior information structure with expected behaviors based on application programming interface (API) usage and/or code paths, and to use dynamic analysis to populate the behavior information structure based on emulated behaviors and their associated statistics, such as the frequency that the features were excited or used. The detonator component 202 may then apply the behavior information structure to a machine learning classifier to generate an analysis result, and use the analysis result to determine whether the application is benign or non-benign.

The application analyzer component 322 may be configured to perform static and/or dynamic analysis operations to identify one or more behaviors and determine whether the identified behaviors are benign or non-benign. For example, for each activity (i.e., GUI screen), the application analyzer component 322 may perform any of a variety of operations, such as count the number of lines of code, count the number of sensitive/interesting API calls, examine its corresponding source code, call methods to unroll source code or operations/activities, examine the resulting source code, recursively count the number of lines of code, recursively count the number of sensitive/interesting API calls, output the total number of lines of code reachable from an activity, output the total number of sensitive/interesting API calls reachable from an activity, etc. The application analyzer component 322 may also be used to generate the activity transition graph for the given application that captures how the different activities (i.e., GUI screens) are linked to one another.

The target selection component 324 may be configured to identify and select high value target activities (e.g., according to the use case, based on heuristics, based on the outcome of the analysis performed by the application analyzer component 322, as well as the exercise information received from the client computing device, etc.). The target selection component 324 may also rank activities or activity classes according to the cumulative number of lines of code, number of sensitive or interesting API calls made in the source code, etc. Examples of sensitive APIs for malware detection may include takePicture, getDeviceId, etc. Examples of APIs of interest for energy bug detection may include Wakelock.acquire, Wakelock.release, etc. The target selection component 324 may also prioritize visiting of activities according to the ranks, and select the targets based on the ranks and/or priorities.

Once the current target activity is reached and explored, a new target may be selected by the target selection component 324. In an embodiment, this may be accomplished by comparing the number of sensitive/interesting API calls that are actually made during runtime with the number of sensitive/interesting API calls that are determined by the app analyzer component 322. Furthermore, based on the observed runtime behavior exhibited by the application, some of the activities (including those that have been explored already) may be re-ranked and explored/exercised again on the emulator.

Based on the activity transition graph determined in the application analyzer component 322, the activity trigger component 326 may determine how to trigger a sequence of activities that will lead to the selected target activities, identify entry point activities from the manifest file of the application, for example, and/or emulate, trigger, or execute the determined sequence of activities using the Monkey tool.

The layout analysis component 328 may be configured to analyze the source code and/or evaluate the layout of display or output screens to identify the different GUI controls (button, text boxes, etc.) visible on the GUI screen, their location, and other properties such as whether a button is clickable.

The trap component 330 may be configured to trap or cause a target behavior. In some embodiments, this may include monitoring activities of the software application to collect behavior information, using the collected behavior information to generate behavior vectors, applying the behavior vectors to classifier models to generate analysis results, and using the analysis results to determine whether a software application or device behavior is benign or non-benign.

Each behavior vector may be a behavior information structure that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used. As an example, the trap component 330 may generate a behavior vector that includes a “location_background” data field whose value identifies the number or rate that the software application accessed location information when it was operating in a background state. This allows the trap component 330 to analyze this execution state information independent of and/or in parallel with the other observed/monitored activities of the software application. Generating the behavior vector in this manner also allows the system to aggregate information (e.g., frequency or rate) over time.

A classifier model may be a behavior model that includes data and/or information structures (e.g., feature vectors, behavior vectors, component lists, decision trees, decision nodes, etc.) that may be used by the computing device processor to evaluate a specific feature or embodiment of the device's behavior. A classifier model may also include decision criteria for monitoring and/or analyzing a number of features, factors, data points, entries, APIs, states, conditions, behaviors, software applications, processes, operations, components, etc. (herein collectively referred to as “features”) in the computing device.

In the client computing device 102, the behavior observer component 302 may be configured to instrument or coordinate various application programming interfaces (APIs), registers, counters or other components (herein collectively “instrumented components”) at various levels of the client computing device 102. The behavior observer component 302 may repeatedly or continuously (or near continuously) monitor activities of the client computing device 102 by collecting behavior information from the instrumented components. In an embodiment, this may be accomplished by reading information from API log files stored in a memory of the client computing device 102.

The behavior observer component 302 may communicate (e.g., via a memory write operation, function call, etc.) the collected behavior information to the behavior extractor component 304, which may use the collected behavior information to generate behavior information structures that each represent or characterize many or all of the observed behaviors that are associated with a specific software application, module, component, task, or process of the client computing device. Each behavior information structure may be a behavior vector that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used.

The behavior extractor component 304 may communicate (e.g., via a memory write operation, function call, etc.) the generated behavior information structures to the behavior analyzer component 306. The behavior analyzer component 306 may apply the behavior information structures to classifier models to generate analysis results, and use the analysis results to determine whether a software application or device behavior is benign or non-benign (e.g., malicious, poorly written, performance-degrading, etc.).

The behavior analyzer component 306 may be configured to notify the actuator component 308 that an activity or behavior is not benign. In response, the actuator component 308 may perform various actions or operations to heal, cure, isolate, or otherwise fix identified problems. For example, the actuator component 308 may be configured to terminate a software application or process when the result of applying the behavior information structure to the classifier model (e.g., by the analyzer module) indicates that a software application or process is not benign.

The behavior analyzer component 306 also may be configured to notify the behavior observer component 302 in response to determining that a device behavior is suspicious (i.e., in response to determining that the results of the analysis operations are not sufficient to classify the behavior as either benign or non-benign). In response, the behavior observer component 302 may adjust the granularity of its observations (i.e., the level of detail at which client computing device features are monitored) and/or change the factors/behaviors that are observed based on information received from the behavior analyzer component 306 (e.g., results of the real-time analysis operations), generate or collect new or additional behavior information, and send the new/additional information to the behavior analyzer component 306 for further analysis. Such feedback communications between the behavior observer and behavior analyzer components 302, 306 enable the client computing device processor to recursively increase the granularity of the observations (i.e., make finer or more detailed observations) or change the features/behaviors that are observed until behavior is classified as either benign or non-benign, until a processing or battery consumption threshold is reached, or until the client computing device processor determines that the source of the suspicious or performance-degrading behavior cannot be identified from further increases in observation granularity. Such feedback communications also enable the client computing device 102 to adjust or modify the classifier models locally in the client computing device 102 without consuming an excessive amount of the client computing device's 102 processing, memory, or energy resources.

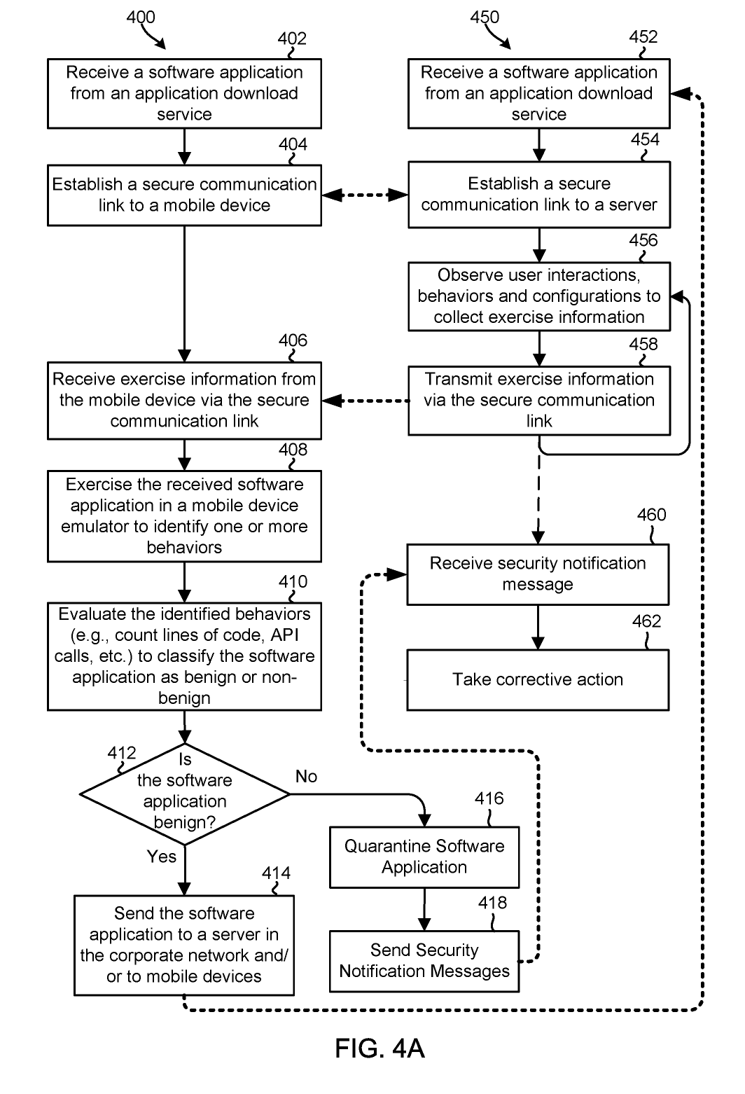

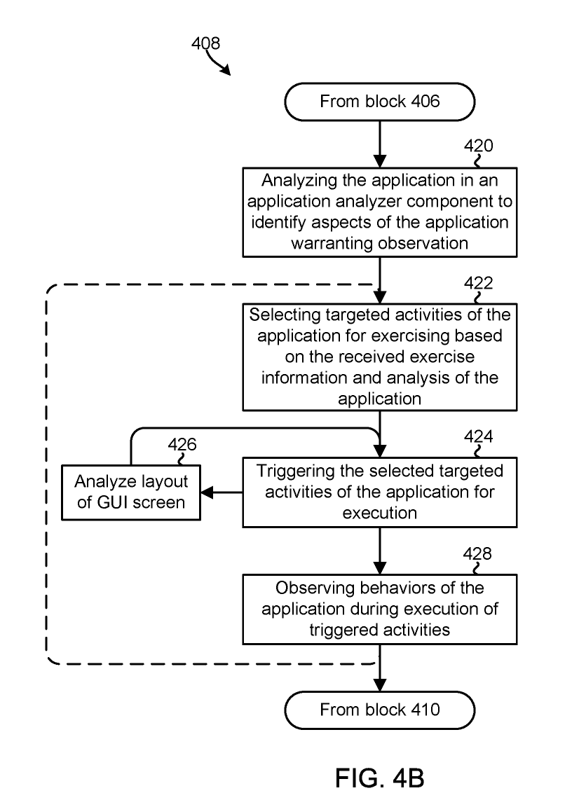

FIG. 4A illustrates a server method 400 and a client computing device method 450 for protecting a corporate network and/or a computing device in accordance with various embodiments. Method 400 may be performed by a server processor in a server computing device that implements all or portions of a detonator component. Method 450 may be performed by a client computing device processor in a client computing device, such as a mobile computing device, resource-constrained computing device, etc.

In block 402 of method 400, the server processor may receive a software application from an application download service. In block 404, the server processor may establish a secure communication link to a client computing device. In some embodiments, the server processor may establish the secure communication link to the client computing device in response to receiving a request message (e.g., a request to establish secure communications) from the client computing device. In some embodiments, the server processor may establish the secure communication link to the client computing device prior to receiving the software application. In some embodiments, the server processor may establish the secure communication link to the client computing device in response to receiving the software application.

In block 406, the server processor may receive exercise information from the client computing device via the secure communication link (e.g., if the user has already used the application on the mobile device and wishes to evaluate it further on the detonator server, etc.). The exercise information may include information identifying a confidence level for the software application, a list of explored activities, list of explored GUI screens, a list of unexplored activities, list of unexplored GUI screens, a list of unexplored behaviors, hardware configuration information, software configuration information, etc.

In block 408, the server processor may exercise the received software application (e.g., in a client computing device emulator, etc.) to identify one or more behaviors. For example, the server processor may execute the application in an emulator to test various features, activities, behaviors, etc. of the software application, which may be selected or determined based on the received exercise information.

In block 410, the server processor may evaluate the identified behaviors (e.g., count lines of code, API calls, etc.) and determine whether the software application may be classified as benign or non-benign.

In determination block 412, the server processor may determine whether the software application is benign.

In response to determining that the software application is benign (i.e., determination block 412=“Yes”), the server processor may send the software application to a server in the corporate network and/or to the client computing device in block 414.

In response to determining that the software application is not benign (i.e., determination block 412=“No”), the server processor may quarantine the software application in block 416, and in block 418, the server processor may send security warning or notification messages to the corporate or IT security system and/or to the client computing device.

In block 452 of the method 450, the client computing device processor may receive a software application from an application download service. In an embodiment, the client computing device processor may receive the software application after the server processor performs the operations in block 414.

In block 454, the client computing device processor may establish a secure communication link to the detonator component (if a secure link does not already exist).

In block 456, the device processor may run or execute the software application, and observe user interactions, behaviors and the device's configurations (e.g., via the on-device security system, etc.) to collect exercise information (e.g., list of explored/unexplored GUI screens, etc.). In block 458, the device processor may send or transmit the collected exercise information to the server via the secure communication link. The device processor may perform the operations in block 456 and 458 continuously or repeatedly until it receives a security notification message in block 460.

In block 462, the device processor may take a corrective action in response to receiving the security notification message. For example, the device processor may terminate or quarantine the software application in block 462.

In exercising the received software application in the mobile device emulator in block 408 of the method 400, the server processor may intelligently execute the software application in an attempt to elicit behaviors that may be non-benign. In other words, leveraging exercise information received from the client device, as well as an analysis of the software application itself, the server processor may select for execution particular activities, GUI interfaces to trigger, and operating modes that analysis indicates have increased probabilities of involving or triggering non-benign behavior. FIG. 4B illustrates an example method of operations that may be performed in block 408 of the method 400 for accomplishing such intelligent execution of the software application.

In block 420, the server processor may analyze the software application in an application analyzer component (e.g., the application analyzer component 322 of FIG. 3) to identify aspects of the application that warrant execution and observation. This analysis may involve identifying suspect API calls, operating modes, data transfers, etc. that have an increased potential for non-benign exploitation.

In block 422, the server processor may select targeted activities (e.g., GUI interactions) for exercising based upon the received exercise information, as well as the analysis of the application. In some embodiments, the selection of targeted activities may be accomplished by a target selection component 324 as described with reference to FIG. 3.

In block 424, the server processor may trigger the selected targeted activities of the software application for execution. For example, the server processor may use a procedure or application to activate a selected GUI icon or interaction to cause the associated operations or activities to execute.

As part of triggering execution of selected targeted activities in block 424, the server processor may analyze the layout of the GUI screen in block 426 to identify particular icons for activation, as well as recognize screen elements that may be indicative of non-benign behavior. For example, the server processor may analyze the layout of the GUI screen in block 426 to identify coordinates of an icon for triggering that is associated with a targeted activity of the software application. As another example, the server processor may analyze the layout of the GUI screen in block 426 to identify portions of the screen associated with activity triggers that are not associated with a visible icon. As a further example, the server processor may analyze the layout of the GUI screen in block 426 to identify displayed icons that will trigger an activity that is inconsistent with a label or indication on the icon (e.g., triggering an activity when the icon is labeled “Cancel”).

In block 428, the server processor may observe behaviors of the software application during execution of the triggered activities. For example, the server processor may generate behavior vectors based upon the observed behaviors during execution of the triggered activities, and apply the behavior vectors to a behavior analysis model as described herein.

Based on the observed runtime behavior of the application, new target activities may be selected for exercising on the emulator. Furthermore, based on the runtime behavior exhibited by the application, some of the activities (including those that have been explored already) may be re-ranked and explored/exercised again on the emulator.

The operations of triggering selected targeted activities for execution and observing the behaviors of the software application during execution of the triggered activities may continue until all selected targeted activities have been executed and observed.

Results of executing and observing behaviors of the selected targeted activities of the software application may be evaluated by the server processor in block 410 as described above with reference to FIG. 4A.

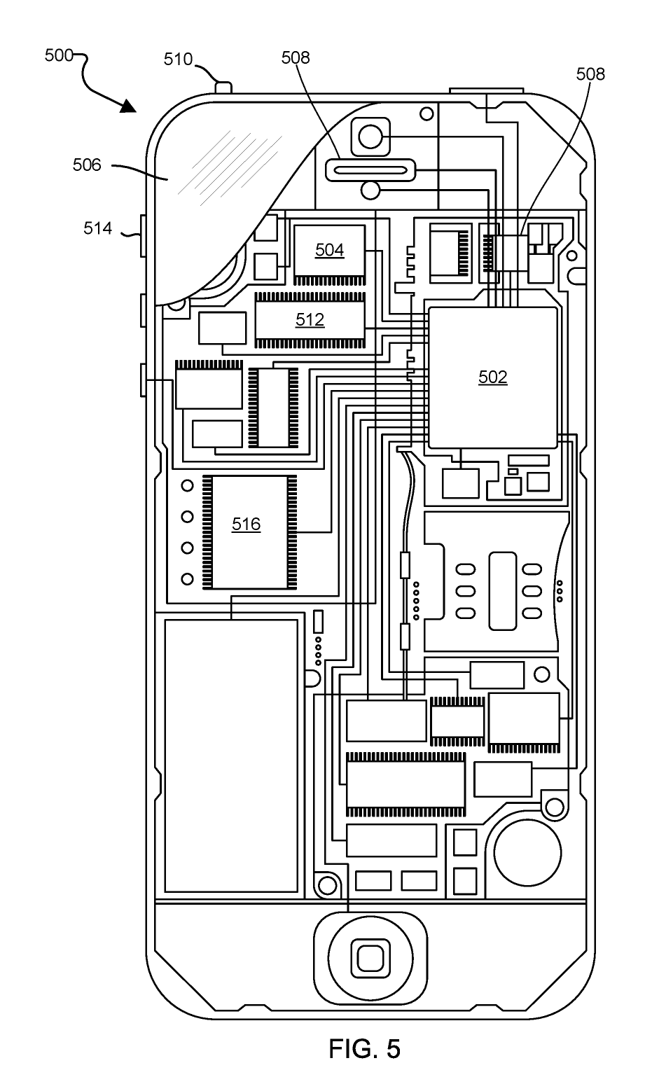

The various embodiments may be implemented on a variety of mobile client computing devices, an example of which is illustrated in FIG. 5. Specifically, FIG. 5 is a system block diagram of a client computing device in the form of a smartphone/cell phone 500 suitable for use with any of the embodiments. The cell phone 500 may include a processor 502 coupled to internal memory 504, a display 506, and a speaker 508. Additionally, the cell phone 500 may include an antenna 510 for sending and receiving electromagnetic radiation that may be connected to a wireless data link and/or cellular telephone (or wireless) transceiver 512 coupled to the processor 502. Cell phones 500 typically also include menu selection buttons or rocker switches 514 for receiving user inputs.

A typical cell phone 500 also includes a sound encoding/decoding (CODEC) circuit 516 that digitizes sound received from a microphone into data packets suitable for wireless transmission and decodes received sound data packets to generate analog signals that are provided to the speaker 508 to generate sound. Also, one or more of the processor 502, wireless transceiver 512 and CODEC 516 may include a digital signal processor (DSP) circuit (not shown separately). The cell phone 500 may further include a ZigBee transceiver (i.e., an Institute of Electrical and Electronics Engineers (IEEE) 802.15.4 transceiver) for low-power short-range communications between wireless devices, or other similar communication circuitry (e.g., circuitry implementing the Bluetooth® or WiFi protocols, etc.).

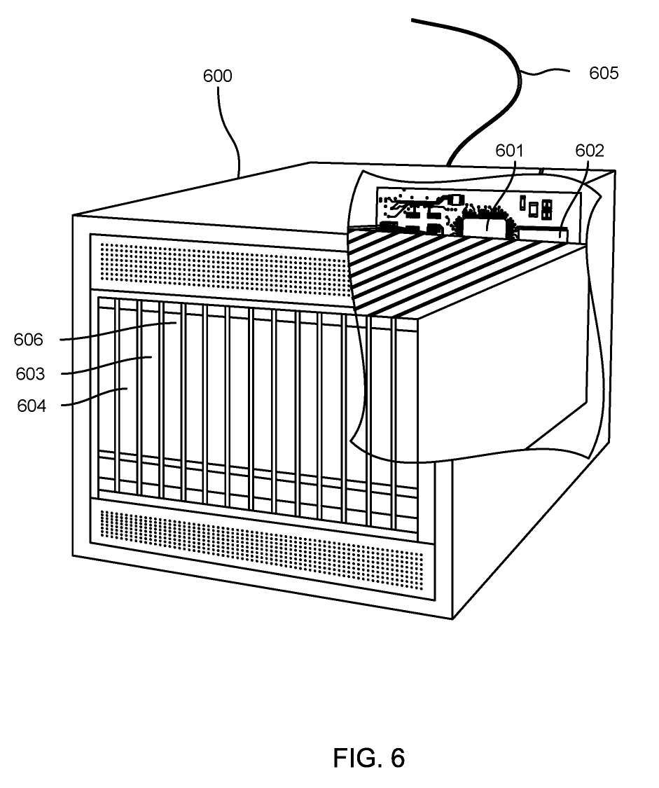

The embodiments and network servers described above may be implemented in variety of commercially available server devices, such as the server 600 illustrated in FIG. 6. Such a server 600 typically includes a processor 601 coupled to volatile memory 602 and a large capacity nonvolatile memory, such as a disk drive 603. The server 600 may also include a floppy disc drive, compact disc (CD) or DVD disc drive 604 coupled to the processor 601. The server 600 may also include network access ports 606 coupled to the processor 601 for establishing data connections with a network 605, such as a local area network coupled to other communication system computers and servers.

The processors 502, 601, may be any programmable microprocessor, microcomputer or multiple processor chip or chips that can be configured by software instructions (applications) to perform a variety of functions, including the functions of the various embodiments described below. In some client computing devices, multiple processors 502 may be provided, such as one processor dedicated to wireless communication functions and one processor dedicated to running other applications. Typically, software applications may be stored in the internal memory 504, 602, before they are accessed and loaded into the processor 502, 601. The processor 502 may include internal memory sufficient to store the application software instructions. In some servers, the processor 601 may include internal memory sufficient to store the application software instructions. In some receiver devices, the secure memory may be in a separate memory chip coupled to the processor 601. The internal memory 504, 602 may be a volatile or nonvolatile memory, such as flash memory, or a mixture of both. For the purposes of this description, a general reference to memory refers to all memory accessible by the processor 502, 601, including internal memory 504, 602, removable memory plugged into the device, and memory within the processor 502, 601 itself.

Many modern computing are resource constrained systems that have relatively limited processing, memory, and energy resources. For example, a client computing device is a complex and resource constrained computing device that includes many features or factors that could contribute to its degradation in performance and power utilization levels over time. Examples of factors that may contribute to performance degradation include poorly designed software applications, malware, viruses, fragmented memory, and background processes. Due to the number, variety, and complexity of these factors, it is often not feasible to evaluate all of the various components, behaviors, processes, operations, conditions, states, or features (or combinations thereof) that may degrade performance and/or power utilization levels of these complex yet resource-constrained systems. As such, it is difficult for users, operating systems, or application programs (e.g., anti-virus software, etc.) to accurately and efficiently identify the sources of such problems. As a result, client computing device users currently have few remedies for preventing the degradation in performance and power utilization levels of a client computing device over time, or for restoring an aging client computing device to its original performance and power utilization levels.

The various embodiments discussed in this application are especially well suited for use in resource constrained-computing devices, such as client computing devices, because the task of intelligently detecting malware is primarily delegated to the detonator server, because they do not require evaluating a very large corpus of behavior information on the client computing devices, generate classifier/behavior models dynamically to account for device-specific or application-specific features of the computing device, intelligently prioritize the features that are tested/evaluated by the classifier/behavior models, are not limited to evaluating an individual application program or process, intelligently identify the factors or behaviors that are to be monitored by the computing device, accurately and efficiently classify the monitored behaviors, and/or do not require the execution of computationally-intensive processes. For all these reasons, the various embodiments may be implemented or performed in a resource-constrained computing device without having a significant negative and/or user-perceivable impact on the responsiveness, performance, or power consumption characteristics of the device.

For example, modern client computing devices are highly configurable and complex systems. As such, the factors or features that are most important for determining whether a particular device behavior is benign or not benign (e.g., malicious or performance-degrading) may be different in each client computing device. Further, a different combination of factors/features may require monitoring and/or analysis in each client computing device in order for that device to quickly and efficiently determine whether a particular behavior is benign or not benign. Yet, the precise combination of factors/features that require monitoring and analysis, and the relative priority or importance of each feature or feature combination, can often only be determined using device-specific information obtained from the specific computing device in which the behavior is to be monitored or analyzed. For these and other reasons, classifier models generated in any computing device other than the specific device in which they are used cannot include information that identifies the precise combination of factors/features that are most important to classifying a software application or device behavior in that specific device. That is, by generating classifier models in the specific computing device in which the models are used, the various embodiments generate improved models that better identify and prioritize the factors/features that are most important for determining whether a software application, process, activity or device behavior is benign or non-benign.

As used in this application, the terms “component,” “module,” “system” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of protecting computing devices from non-benign software applications, comprising:
receiving, by a processor in a server computing device, a software application from an application download service;
establishing, by the processor, a secure communication link to a client computing device;
receiving, by the processor, exercise information from the client computing device via the secure communication link;
using the received exercise information by the processor to exercise the received software application in a client computing device emulator to identify one or more behaviors; and
determining by the processor whether the identified one or more behaviors are benign.

2. The method of claim 1, wherein using the received exercise information by the processor to exercise the received software application in the client computing device emulator to identify one or more behaviors comprises:
analyzing the software application in an application analyzer component of the client computing device emulator to identify aspects of the software application warranting observation;
selecting targeted activities of the software application for exercising based on the received exercise information and analysis of the software application;
triggering the selected targeted activities of the software application for execution; and
observing behaviors of the software application during execution of triggered activities, and further selecting new target activities based on runtime behavior of the software application.

3. The method of claim 2, further comprising:
analyzing a layout of a graphical user interface; and
using results of analysis of the graphical user interface when triggering the selected targeted activities of the software application for execution.

4. The method of claim 1, further comprising:
quarantining by the processor the software application received from the application download service in response to determining that the identified one or more behaviors are not benign; and
sending a notification message that includes information identifying the software application as non-benign to the client computing device.

5. The method of claim 1, further comprising:
sending the software application received from the application download service to the client computing device in response to determining that the identified one or more behaviors are benign.

6. The method of claim 5, further comprising:
receiving additional exercise information from the client computing device via the secure communication link in response to sending software application received from the application download service to the client computing device;
using the additional exercise information to further exercise the received software application and identify an additional behavior; and
determining whether the identified additional behavior is benign.

7. The method of claim 1, wherein receiving exercise information from the client computing device comprises receiving one or more of:
information identifying a confidence level for the software application;
a list of explored activities;
a list of explored graphical user interface (GUI) screens;
a list of unexplored activities;
a list of unexplored GUI screens;
a list of unexplored behaviors;
hardware configuration information; or
software configuration information.

8. The method of claim 1, further comprising:
computing a risk score for the received software application; and
sending the computed risk score to the client computing device via the secure communication link.

9. The method of claim 1, further comprising:
receiving the software application in the client computing device;
commencing execution of the software application on the client computing device;
monitoring activities of the software application to collect behavior information;
generating a vector data structure that describes the collected behavior information;
applying the vector data structure to a machine learning classifier model to generate an analysis result; and
using the analysis result to determine whether the software application is benign.

10. The method of claim 9, further comprising:
sending the analysis result from the client computing device to the server computing device as exercise information in response to determining that the software application is not benign.

11. The method of claim 1, further comprising:
receiving a communication request message from the client computing device; and
establishing the secure communication link to the client computing device in response to receiving the communication request message from the client computing device.

12. A server computing device, comprising:
a processor configured with processor-executable instructions to perform operations comprising:
receiving a software application from an application download service;
establishing a secure communication link to a client computing device;
receiving exercise information from the client computing device via the secure communication link;
using the received exercise information to exercise the received software application in a client computing device emulator to identify one or more behaviors; and
determining whether the identified one or more behaviors are benign.

13. The server computing device of claim 12, wherein the processor is configured with processor-executable instructions to perform operations such that using the received exercise information by the processor to exercise the received software application in the client computing device emulator to identify one or more behaviors comprises:
analyzing the software application in an application analyzer component of the client computing device emulator to identify aspects of the software application warranting observation;
selecting targeted activities of the software application for exercising based on the received exercise information and analysis of the software application;
triggering the selected targeted activities of the software application for execution; and
observing behaviors of the software application during execution of triggered activities, and further selecting new target activities based on runtime behavior of the software application.

14. The server computing device of claim 13, wherein the processor is configured with processor-executable instructions to perform operations further comprising:
analyzing a layout of a graphical user interface; and
using results of analysis of the graphical user interface when triggering the selected targeted activities of the software application for execution.

15. The server computing device of claim 12, wherein the processor is configured with processor-executable instructions to perform operations further comprising:
quarantining the software application received from the application download service in response to determining that the identified one or more behaviors are not benign; and
sending a notification message that includes information identifying the software application as non-benign to the client computing device.

16. The server computing device of claim 15, wherein the processor is configured with processor-executable instructions to perform operations further comprising:
sending the software application received from the application download service to the client computing device in response to determining that the identified one or more behaviors are benign.

17. The server computing device of claim 16, wherein the processor is configured with processor-executable instructions to perform operations further comprising:
receiving additional exercise information from the client computing device via the secure communication link in response to sending software application received from the application download service to the client computing device;
using the additional exercise information to further exercise the received software application and identify an additional behavior; and
determining whether the identified additional behavior is benign.

18. The server computing device of claim 12, wherein the processor is configured with processor-executable instructions to perform operations such that receiving exercise information from the client computing device comprises receiving one or more of:
information identifying a confidence level for the software application;
a list of explored activities;
a list of explored graphical user interface (GUI) screens;
a list of unexplored activities;
a list of unexplored GUI screens;
a list of unexplored behaviors;
hardware configuration information; or
software configuration information.

19. The server computing device of claim 12, wherein the processor is configured with processor-executable instructions to perform operations further comprising:
computing a risk score for the received software application; and
sending the computed risk score to the client computing device via the secure communication link.

20. The server computing device of claim 12, wherein the processor is configured with processor-executable instructions to perform operations further comprising:
receiving a communication request message from the client computing device; and
establishing the secure communication link to the client computing device in response to receiving the communication request message from the client computing device.

21. A non-transitory computer readable storage medium having stored thereon processor-executable software instructions configured to cause a processor in a server computing device to perform operations comprising:
receiving a software application from an application download service;
establishing a secure communication link to a client computing device;
receiving exercise information from the client computing device via the secure communication link;
using the received exercise information to exercise the received software application in a client computing device emulator to identify one or more behaviors; and
determining whether the identified one or more behaviors are benign.

22. The non-transitory computer readable storage medium of claim 21, wherein the stored processor-executable instructions are configured to cause a processor to perform operations such that using the received exercise information by the processor to exercise the received software application in the client computing device emulator to identify one or more behaviors comprises:
analyzing the software application in an application analyzer component of the client computing device emulator to identify aspects of the software application warranting observation;
selecting targeted activities of the software application for exercising based on the received exercise information and analysis of the software application;
triggering the selected targeted activities of the software application for execution; and
observing behaviors of the software application during execution of triggered activities, and further selecting new target activities based on runtime behavior of the software application.

23. The non-transitory computer readable storage medium of claim 22, wherein the stored processor-executable instructions are configured to cause a processor to perform operations further comprising:
analyzing a layout of a graphical user interface; and
using results of analysis of the graphical user interface when triggering the selected targeted activities of the software application for execution.

24. The non-transitory computer readable storage medium of claim 21, wherein the stored processor-executable instructions are configured to cause a processor to perform operations further comprising:
quarantining the software application received from the application download service in response to determining that the identified one or more behaviors are not benign; and
sending a notification message that includes information identifying the software application as non-benign to the client computing device.

25. The non-transitory computer readable storage medium of claim 21, wherein the stored processor-executable instructions are configured to cause a processor to perform operations further comprising:
sending the software application received from the application download service to the client computing device in response to determining that the identified one or more behaviors are benign.

26. The non-transitory computer readable storage medium of claim 25, wherein the stored processor-executable instructions are configured to cause a processor to perform operations further comprising:
receiving additional exercise information from the client computing device via the secure communication link in response to sending software application received from the application download service to the client computing device;
using the additional exercise information to further exercise the received software application and identify an additional behavior; and
determining whether the identified additional behavior is benign.

27. The non-transitory computer readable storage medium of claim 21, wherein the stored processor-executable instructions are configured to cause a processor to perform operations such that receiving exercise information from the client computing device comprises receiving one or more of:
information identifying a confidence level for the software application;
a list of explored activities;
a list of explored graphical user interface (GUI) screens;
a list of unexplored activities;
a list of unexplored GUI screens;
a list of unexplored behaviors;
hardware configuration information; or
software configuration information.

28. The non-transitory computer readable storage medium of claim 21, wherein the stored processor-executable instructions are configured to cause a processor to perform operations further comprising:
computing a risk score for the received software application; and
sending the computed risk score to the client computing device via the secure communication link.

29. The non-transitory computer readable storage medium of claim 21, wherein the stored processor-executable instructions are configured to cause a processor to perform operations further comprising:
receiving a communication request message from the client computing device; and
establishing the secure communication link to the client computing device in response to receiving the communication request message from the client computing device.

30. A computing device, comprising:
means for receiving a software application from an application download service;
means for establishing a secure communication link to a client computing device;
means for receiving exercise information from the client computing device via the secure communication link;
means for using the received exercise information to exercise the received software application in a client computing device emulator to identify one or more behaviors; and
means for determining whether the identified one or more behaviors are benign.
